(19) United States
(12) Patent Application Publication
(10) Pub. No.: US 2012/0255712 A1
(43) Pub. Date: Oct. 11, 2012

(54) APPARATUS AND METHOD FOR CONDENSING VAPOR IN A VESSEL

(75) Inventors: Günther KIRCHNER, Frankenthal (DE); Markus MAURER, Ludwigshafen (DE)

(73) Assignee: BASF SE, Ludwigshafen (DE)

(21) Appl. No.: 13/438,197

(22) Filed: Apr. 3, 2012

Related U.S. Application Data
(60) Provisional application No. 61/472,645, filed on Apr. 7, 2011.

(51) Int. Cl. B01D 5/00; F28B 1/02

(52) U.S. Cl. 165/113

(57) ABSTRACT

Apparatus for condensing vapor in a vessel, which comprises a vapor space (10) and a condensation space (11) which are adjacent to one another in the horizontal direction, where the vapor space (10) having a horizontal cross section is open in the downward direction, the condensation space (11) is closed in the downward direction by at least one bottom element (14) and at least one essentially vertically aligned bundle of heat exchange elements (20) is arranged in the condensation space, wherein wall elements (40) are present between vapor space and condensation space and partly separate the two spaces from one another and define a vertical transition plane from the vapor space into the condensation space and at least one deflection element (30) is present in the vapor space to divert the vapor ascending from below into the vapor space in the direction of the transition plane and owing to its shape brings about an essentially horizontal flow of vapor through the transition plane onto the heat exchange elements.

The present application incorporates the provisional U.S. application 61/472,645 filed on Apr. 7, 2011 by reference.

The present invention relates to an apparatus for condensing vapor in a vessel, which comprises a vapor space and a condensation space which are adjacent to one another in the horizontal direction, where the vapor space having a horizontal open cross section is open in the downward direction, the condensation space is closed in the downward direction by at least one bottom element and at least one essentially vertically aligned bundle of heat exchange elements is arranged in the condensation space. The invention further relates to a column in which an apparatus according to the invention is arranged as overhead condenser in the top region of the column. Furthermore, the present invention relates to a method of condensing a vapor stream by means of an apparatus according to the invention.

In thermal separation technology, apparatuses and methods for condensing vapor which ascends in a column have been known for a long time. Such apparatuses are also referred to as condensers. Thus, for example, the textbook “Destillier- and Rektifiziertechnik” by E. Kirschbaum, 4th edition, Springer Verlag (1969) discloses condensers which are installed as independent apparatuses outside the column (pp. 157-158), condensers which are installed directly on top of the top of the column (pp. 472-473) and condensers which are integrated into the top of the column (p. 410). These apparatuses fulfill the task of partially or completely condensing vapor ascending in the column. The liquid obtained is usually collected and recirculated in its entirety or in part to the column and/or taken off in its entirety or in part as overhead off take stream from the separation process.

A variety of concepts and variants, for example in respect of the type of heat exchange elements such as plate heat exchangers or shell-end-tube exchangers or in respect of the flow of vapor to be condensed and heat transfer medium, are known for the specific configuration of condensers. In the case of condensation in a shell-and-tube heat exchanger, the bundle of tubes can, for example, be arranged horizontally or vertically and the vapor to be condensed can be conveyed in the tubes or around the tubes. If the vapor to be condensed is conveyed around the tubes, it can be conducted through the bundle either along the tubes or transverse to the tubes.

Apparatuses for condensing vapor which are integrated into one column offer, inter alia, the advantage that a vapor line from the column to the condenser can be omitted and it is generally the case that a smaller construction space is required than when the condenser is located outside the column.

One variant of such a condenser integrated into the column is described by the German patent DE 197 12 148 C1. At the top of the column, there is a housing which is open at the top and is made of metal sheets and bounds a space in which a bundle of plate heat exchangers is accommodated. The housing is bounded at the bottom by a housing bottom which is configured as a bottom plate running obliquely to the column wall. Vapor ascending from the column is diverted by the curvature of the column lid, enters the housing from the top and flows downward along the heat exchange plates. The condensate formed drips off downward from the heat exchange plates and is collected by the housing bottom. As a result of the oblique arrangement of the housing bottom, the condensate collects on the column wall as lowest point and is taken off through an opening in the column wall. A cooling medium flows from the bottom upward in countercurrent through the heat exchange plates. An inlet and an outlet for the cooling medium are provided in the column wall for this purpose. To prevent condensate from being partially revaporized by ascending hot vapor, the housing bottom is provided with thermal insulation.

DE 198 30 163 A1 describes a similar concept for a condenser integrated into the top of the column. A housing made of metal sheets in which a bundle of plate heat exchangers is installed is provided. The vapor ascending in the column flows from the top downward parallel to the heat exchange plates. The condensate formed drips onto the obliquely arranged housing bottom and is taken off at the lowest point through an opening in the column wall. In contrast to the above-cited patent, the bundle is in this case not fixed to the column wall but fastened in an exchangeable manner on the column lid. The connections for the cooling medium are likewise located in the column lid. The heat exchanger bundle can be taken out, for example for cleaning purposes, by opening the column lid.

In all the apparatuses described above, the vapor ascending from the column is diverted at the top of the column and flows from the top downward through the bundle of plate heat exchangers. This causes a pressure drop which is generally undesirable and, particularly in high vacuum applications, restricts this type of condensers.

It is an object of the invention to provide an apparatus and a process for condensing vapor which widens the range of use in terms of the operating conditions, while retaining the advantages of integration in a vessel, for example a column.

This object is achieved according to the invention by an apparatus for condensing vapor according to claim 1. The object is also achieved by a column according to claim 11, into which an apparatus according to the invention is integrated. Furthermore, the object is achieved by a method of condensing a vapor stream according to claims 14 and 15. Advantageous embodiments and further developments of the invention are indicated in the dependent claims 2 to 10 and also 12 and 13.

An apparatus according to the invention for condensing vapor in a vessel comprises a vapor space and a condensation space which are adjacent to one another in the horizontal direction, where the vapor space having a horizontal open cross section is open in the downward direction, the condensation space is closed in the downward direction by at least one bottom element and at least one essentially vertically aligned bundle of heat exchange elements is arranged in the condensation space. Wall elements are present between vapor space and condensation space and partly separate the two spaces from one another and define a vertical transition plane from the vapor space into the condensation space. Furthermore, at least one deflection element is present in the vapor space to divert the vapor ascending from below into the vapor space in the direction of the transition plane and owing to its shape brings about an essentially horizontal flow of vapor through the transition plane onto the heat exchange elements.

Here and in the following, a vessel is a structure which in its interior has a hollow space in which the vapor space and the condensation space are located. In a preferred embodiment of the invention, the vessel is a structure which is bounded in the horizontal direction by a contiguous wall, in the downward direction by a bottom and in an upward direction by a lid. Such a vessel has at least one vapor inlet through which vapor can flow into the interior of the vessel. Such a vapor inlet is preferably located at the lower end of the vessel. It can be realized, for example, in the form of a pipe section or flange.

In a further preferred embodiment, the vessel is an integral part of a larger construction, for example a section of a column. The vessel is particularly preferably formed by the top region of a column which is bounded laterally by the column wall. The vessel can be bounded in an upward direction by the column lid, while it is open at the bottom so that vapor ascending in the column can get from below into the vessel.

Between vapor space and condensation space in the vessel, there are wall elements which partly separate the two spaces from one another. They are arranged in such a way that they leave open an essentially vertically aligned area between vapor space and condensation space, hereinafter referred to as vertical transition plane. The wall elements are preferably joined to the vessel wall so as to be impermeable to fluids and project inward from the respective vessel wall. This ensures that the vapor can get into the condensation space only through the vertical transition plane from the vapor space and bypass flows are avoided.

While the vapor space is open in a downward direction, the condensation space is closed at the bottom by at least one bottom element, hereinafter also referred to as first bottom element. The first bottom element is configured and joined to the vessel wall and the wall elements so as to be impermeable to fluids in such a way that it bounds the condensation space in a downward direction and prevents intrusion of vapor from below. The first bottom element is preferably arranged at least partly below the at least one bundle of heat exchange elements, so that condensate formed on this bundle can be collected by the first bottom element. Owing to its shape, either alone or together with part of the vessel wall and/or the wall elements, the first bottom element forms a first collection space for the condensate. The bottom element particularly preferably starts out from the place above which the bundle of heat exchange elements is located, inclined downward to the vessel wall. This makes it possible for condensate collecting on the bottom element to be taken off in a simple manner, e.g. through an opening in the vessel wall at the lowest point of the bottom element. However, the bottom element can also have a different configuration, for example essentially horizontal with a conical downflow region from which the collected condensate can be taken off via a pipe. In a further preferred embodiment, the bottom element is configured as a double metal sheet having an insulating layer. This avoids excessive heating of the bottom element on the inside of the condensation space and thus vaporization of condensate which has been formed. In one embodiment, the insulating layer is formed by a gas volume enclosed in the bottom element; the gas is particularly preferably air. In the case of a gas volume as insulating layer, the underside of the bottom element preferably has a hole via which the gas volume is connected to the surroundings. In a further embodiment, the insulating layer comprises a solid insulating material, for example a stable plastic or glass wool.

In the upward direction, the condensation space can be open or bounded. In one embodiment according to the invention, the vessel has a lid or an upper wall which forms the upper boundary of the condensation space. In this case, the wall elements extend upward to such an extent that the vapor from the vapor space cannot go around the wall elements into the condensation space but has to flow through the vertical transition plane. In a further embodiment, the apparatus according to the invention is used in a region of the vessel which has no upper boundary determined by the construction. In this case, the condensation space is preferably open in an upward direction, while the vapor space is bounded at the top. This upper boundary of the vapor space is preferably realized by means of a covering element which is, in a manner analogous to the bottom element, joined to the vessel wall and the wall elements so as to be impermeable to fluids so that no vapor can escape upward from the vapor space but instead flows through the vertical transition plane into the condensation space.

According to the invention, at least one bundle of heat exchange elements which is oriented essentially vertically is arranged in the condensation space. This means that the dimension of the bundle in the vertical direction is greater than in any horizontal direction. The bundle can also be slightly inclined relative to the longitudinal axis of the vessel, with an angle of inclination of from −20° to +20° still being considered to be slight. Viewed in cross section, the bundle of heat exchange elements is preferably arranged in a middle region of the vessel, with the middle region being considered to be a circle which is concentric with the cross section of the vessel and has a diameter of preferably not more than 80%, particularly preferably not more than 60%, of the diameter of the vessel.

In a preferred embodiment of the apparatus of the invention, the at least one bundle of heat exchange elements is arranged in the condensation space directly on the vertical transition plane, so that vapor going over from the vapor space into the condensation space impinges directly on the heat exchange elements.

The vapor space is the space in the vessel which is adjacent to the condensation space in a horizontal direction. It is open in a downward direction and commences at the level of the bottom element of the condensation space. A cross section through the vessel at this point gives, firstly, an area which is occupied by the condensation space and is impermeable to the vapor ascending from below and, secondly, an area which represents the entry into the vapor space and through which the vapor can flow upward. The latter area will hereinafter also be referred to as horizontal open cross-sectional area. Laterally, the vapor space is bounded by the vessel wall and also the wall elements and the vertical transition plane.

According to the invention, at least one deflection element is accommodated in the vapor space; this is configured so that vapor ascending from below into the vapor space is diverted in the direction of the heat exchange elements and the vapor is directed essentially horizontally onto the bundle of heat exchange elements on going from the vapor space into the condensation space. This type of inflow is also referred to as “x-flow” in heat transfer engineering. In contrast to concepts known from the prior art, in which the vapor stream is deflected by about 180°, according to the invention the vapor stream is deflected by only about 90°. As a result, the pressure drop associated with the deflection is significantly reduced.

In an advantageous variant of the invention, the at least one deflection element is configured as a plate having a lower region, an upper region and a transition region between the upper and lower regions. The lower region runs essentially vertically and parallel to the heat exchanger bundle, while the upper region runs essentially horizontally. The deflection element preferably extends very close to the bundle, but the latter should still be able to be replaced without problems without hindrance by the at least one deflection element. A spacing of from 1 to 2 cm between the end of the at least one deflection element and the heat exchanger bundle has been found to be appropriate in this respect. The transition region connects the upper and lower regions via a rounding which can, for example, be a quarter circle or quarter ellipse.

The at least one deflection element can be made of various materials, for example a metal or a rigid polymer such as polyamide. It is preferably made of metal, in particular steel. The material thickness is determined by the strength characteristics of the material used. The deflection element or elements is/are preferably welded to the vessel wall. Depending on the specific circumstances and the choice of material, other fastening measures such as adhesive bonding, screwing or clip connections are also possible.

The vapor space is preferably bounded at the top. In one embodiment of the invention, the vessel has a lid or an upper wall which forms the upper boundary of the vapor space. The lid frequently has a rounding so that ascending vapor is diverted in the direction of the vertical transition plane without appreciable turbulence and resistance due to the vessel wall. To assist or in cases in which resistances such as corners and edges are present in the flow path, guide elements, for example rounded guide plates, can be provided in the transition region from the vessel wall to the vessel lid in order to ensure vapor flow which is ideally free of turbulence. In a further embodiment, the apparatus of the invention is used in a region of the vessel in which there is no upper boundary due to the construction. In this case, the upper boundary is preferably realized by a covering element which is joined to the vessel wall in such a way that no vapor can escape in an upward direction apart from a small amount of vapor which may be able to flow through the gap between the end of the covering element and the bundle of heat exchange elements. The covering element is particularly preferably configured as a deflection element which, owing to its shape, ensures vapor flow which is ideally free of turbulence.

In a preferred embodiment of the apparatus of the invention, at least two deflection elements are present in the vapor space and are arranged in such a way that they divide the horizontal open cross-sectional area at the entry into the vapor space into at least three entry areas and divide the vertical transition plane from the vapor space into the condensation space into at least three exit areas, where the number of entry areas is the same as the number of exit areas.

The bottom ends of the deflection elements together with the wall elements, the bottom element and the vessel wall, viewed in cross section, define entry areas over which the vapor flowing upward is divided. The sum of the entry areas corresponds to the open cross-sectional area. Analogously, the upper ends of the deflection elements together with the wall elements and optionally the upper boundary of the vessel define exit areas through which the respective substreams flow from the vapor space into the condensation space. Between the entry areas and the exit areas, channels through which proportions of the vapor flow are defined by the deflection elements, the wall elements, the bottom element, the vessel wall and optionally the upper boundary of the vessel.

In a further preferred apparatus, the geometric areas of the entry areas are selected so that the volume flows through the respective entry areas differ from one another by not more than 10%, particularly preferably not more than 5%, and the geometric areas of the exit areas differ from one another by not more than 10%, particularly preferably not more than 5%.

The geometric area of the horizontal open cross-sectional area is determined by the vessel diameter and the dimensions and arrangement of the elements such as wall elements and bottom element which bound the condensation space. The geometric areas of the individual entry areas can be fixed by appropriate selection of the number of deflection elements and the dimensions, arrangement and shape thereof. Analogously, the individual exit areas can be fixed by appropriate selection of the number of deflection elements and the dimensions, arrangement and shape thereof.

The total volume flow of the ascending vapor is divided by the entry areas into partial volume flows which flow through the respective channels. If the vapor flow is nonuniformly distributed over the cross section on entry into the vapor space, the ratios of the entry areas relative to one another are preferably selected so that the partial volume flows differ from one another by not more than the values indicated above. A smaller entry area is selected in a region of high vapor flow than in a region having low vapor flow. The distribution of the ascending vapor flow over the cross-sectional area can be determined experimentally or by simulation, for example using CFD (computational fluid dynamics) models.

In the case of a vapor flow which is uniform over the cross section at the entry into the vapor space, the partial volume flows are proportional to the respective entry areas. In such a case, preference is given to an apparatus in which the geometric areas of the entry areas differ from one another by not more than 10%, particularly preferably not more than 5%, and the geometric areas of the exit areas differ from one another by not more than 10%, particularly preferably not more than 5%.

Selection of the entry areas in the preferred ranges makes it possible to achieve uniform distribution of the partial volume flows at the exit and thus a uniform distribution of the vapor to be condensed on the heat exchange elements. This has the advantage that the heat exchange elements can be utilized efficiently.

In an advantageous embodiment, the deflection elements of the apparatus of the invention have a rounding which is such that the vapor flow is essentially free of turbulence or eddies at the transition from the vertical flow direction at the entry into the vapor space to the horizontal flow direction at the exit from the vapor space. The rounding is particularly preferably in the form of a quarter circle or a quarter ellipse, so that the vapor flow follows the shape of the rounding. The specific configuration of the deflection elements also depends on the space available in the vessel. A rounding without corners, edges or other hindrances in the flow path is preferred in any case. The preferred configuration of the rounding contributes significantly to a further reduction in the pressure drop on deflection of the vapor.

In a further advantageous embodiment of the invention, a further bundle of additional heat exchange elements is present behind, viewed in the flow direction of the vapor, the bundle of heat exchange elements in the condensation space. On going over from the vapor space to the condensation space, the vapor firstly flows through the bundle of heat exchange elements and subsequently through the bundle of additional heat exchange elements. This measure enables the cooling power to be divided among at least two bundles, which offers greater flexibility in design and process operation. Thus, for example, the vapor can be partially condensed in the first bundle of heat exchange elements by setting a first temperature level on the cooling side of the heat exchange elements. Complete condensation of the remaining vapor can subsequently be realized in the bundle of additional heat exchange elements by setting a second, lower temperature level. This division of the cooling power required enables, for example, total condensation to be achieved while saving a proportion of the usually expensive cooling medium at lower temperature in favor of a more expensive cooling medium at higher temperature.

As heat exchange elements and as additional heat exchange elements, it is possible to use all elements known to those skilled in the art which are also used in conventional condensers, for example plate heat exchangers such as sealed plate heat exchangers, fully welded plate heat exchangers, “Thermobleche” or bundles of tubes; in the latter case, it can be smooth or have additional elements such as fins. The heat exchange elements and/or additional heat exchange elements can be selected and designed as a function of the specific requirements for the condensation of the vapor and the circumstances in respect of the cooling medium available. The cooling medium can flow through the heat exchange elements and/or additional heat exchange elements in one or more streams. The elements are preferably configured in such a way that the cooling medium flows through them in two streams. The flow direction of the cooling medium depends on the type of heat exchange elements selected. The flow of cooling medium through the heat exchange elements and/or additional heat exchange elements is preferably essentially vertical.

In a preferred embodiment of the apparatus of the invention, the bundle of heat exchange elements and/or the bundle of additional heat exchange elements is a bundle of tubes. Further preference is given to a configuration in which the in each case two tubes are joined at their lower end in such a way that a bundle of U-tubes is obtained. The bundle of tubes can have two or more flow paths through the tubes. Owing to the essentially vertical arrangement of the heat exchanger bundle, both the entry and the exit for the cooling medium are located at the upper end of the bundle in this embodiment. In a further embodiment, the tubes are connected in such a way that the cooling medium flows through them in a plurality of streams. In an alternative embodiment, the bundle has a floating head or is equipped with two fixed tube plates.

In an advantageous further development of the apparatus with additional heat exchangers, a second bottom element is arranged in the condensation space at least partly below the bundle of additional heat exchange elements, so that condensate formed on this bundle can be collected by the second bottom element. Owing to its shape, the second bottom element either alone or together with part of the vessel wall and/or the wall elements forms a second collection space for condensate formed on the additional heat exchangers. The second bottom element is particularly preferably inclined downward toward the vessel wall starting from the point above which the bundle of additional heat exchange elements is located. This makes it possible for condensate collecting on the bottom element to be taken off in a simple manner, e.g. through an opening in the vessel wall at the lowest point of the bottom element. However, the bottom element can also be configured in other ways, for example essentially horizontally with a conical downflow region from which the collected condensate can be taken off via a pipe. In a further preferred embodiment, the bottom element is designed as a double plate having an insulating layer. This type of bottom element can be designed analogously to the above description of the first bottom element.

In a further advantageous embodiment of the apparatus having additional heat exchangers, the second collection space is separated from the first collection space and at least two outlets are present to allow the condensates to be discharged separately from the two collection spaces. Such a design of the apparatus of the invention allows the condensate to be divided into at least two fractions. Thus, for example, components of the vapor having a comparatively high boiling point can be separated off by condensation at a particular temperature level on the first bundle of heat exchange elements while components having comparatively low boiling points remain in the vapor phase. The remaining vapor can subsequently be passed to the bundle of additional heat exchange elements and there condensed further or completely at a lower temperature level. In this way, two condensates which differ in their composition can be obtained.

The invention further provides a column in which an apparatus according to the invention for condensing vapor is located and which further comprises one or more cooling medium inlets and one or more cooling medium outlets for the heat exchange elements and optionally additional heat exchange elements and also at least one outlet for discharge of the condensate collecting in the condensation space. The apparatus of the invention is particularly preferably arranged as overhead condenser in the top region of the column.

In a further advantageous embodiment, the lid of the column has an accommodation device on which the bundle of heat exchange elements is fastened. In one embodiment according to the invention, the bundle is fixed to the column lid, as described, for example, in DE 198 30 163 A1. In a preferred embodiment, the bundle of heat exchange elements is installed in a detachable manner in the column. If additional heat exchange elements are present, a bundle of additional heat exchange elements is also installed in the column in a detachable manner in this embodiment. The detachable installation can be effected, for example, via a pipe section in the lid of the column. The pipe section can be rectangular, round or a mixed form of the two. The shape of pipe section to be preferred has to be determined in each individual case in the light of operating conditions such as pressure and temperature and also as a function of the material selected and the open area required. Furthermore, detachable installation can be achieved by the heat exchanger bundle being screwed into the column. For installation and removal of the bundle, it is advantageous for the bundle to be mounted in a guide, e.g. in guide elements, for example guide rails, which are aligned essentially vertically and are fixed to the column and/or the wall elements. The wall elements can also be configured such that parts of them function as guide elements.

Detachable installation offers the advantage that the bundle of heat exchange elements and optionally a bundle of additional heat exchange elements can easily be removed from the column and installed again, e.g. for cleaning purposes or in the case of repair of the bundle being required.

Preference is also given to an embodiment in which the accommodation device of the column comprises a double flange. The bundle of heat exchange elements is joined in a gastight manner to the column by means of a first flange and the cooling medium side of the heat exchange elements is accessible via the second flange. The first flange is preferably joined tightly to the column lid. The heat exchange elements are installed in such a way that their inlet and outlet openings for the cooling medium are still accessible from the outside when the first flange is closed. If additional heat exchange elements are present, these are preferably installed in the same way. The space of the inlet and outlet openings is sealed off from the surroundings by means of the second flange. This embodiment is advantageous for applications in which the pressure in the column differs significantly from ambient pressure, in particular for applications in which a reduced pressure prevails in the column. Due to the double flange construction, the heat exchange elements can be, for example, inspected or cleaned on the side of the cooling medium without the pressure conditions in the column having to be suspended.

The apparatus of the invention for condensing vapor and columns according to the invention are suitable for a variety of applications. They can be particularly advantageously employed in processes in which minimization of the pressure drop is of great importance. The invention therefore further provides a method of condensing a vapor stream by means of an apparatus according to the invention, wherein the absolute pressure in the vapor space does not exceed 200 mbar, particularly preferably 50 mbar, in particular 10 mbar.

The invention further relates to a method of condensing a vapor stream by means of an apparatus according to the invention, wherein the vapor stream comprises components which form deposits on the heat exchange elements during condensation. In particular, an embodiment of the apparatus of the invention having detachable heat exchanger bundles has proved to be advantageous in this case. Replacement or installation and removal for cleaning purposes can in this case be effected simply and inexpensively.

The apparatus of the invention has a compact construction and avoids the disadvantages of known types of construction such as pipes causing a pressure drop. Compared to known integrated condenser concepts, the apparatus of the invention offers the advantage of a lower pressure drop, which is particularly advantageous in applications in a vacuum or high vacuum. In particular, the deflection of the vapor stream from the vertical direction to a horizontal direction contributes to the reduced pressure drop.

The resulting pressure drop is determined essentially by the free open area between vapor space and condensation space on entry into the bundle of heat exchange elements. This free open area is limited in known constructions as described, for example, in the documents DE 197 12 148 C1 and DE 198 30 163 A1 by the column cross section. Enlargement is only possible by widening the column cross section in a costly manner or by installing fewer heat exchange elements in the available column cross section. In the apparatus according to the invention, this free open area can be enlarged simply and inexpensively by lengthening the bundle of heat exchange elements and thus the column length. In contrast to known integrated condensers, the length of the heat exchange elements can be chosen within a significantly greater range without the efficiency of the condensation decreasing significantly. This advantage, too, results from the division and diversion of the vapor stream by the deflection elements according to the invention.

The invention can be realized in various vessels. It displays particular advantages in a variety of columns for separating systems of materials, for example columns for distillation, rectification, reactive distillation, in each case with or without a vertical dividing wall.

The invention will be illustrated below with the aid of the drawings; the drawings are to be interpreted as an in-principle presentation. They do not constitute any restriction of the invention, for example in respect of specific dimensions or design variants of components. In the figures:

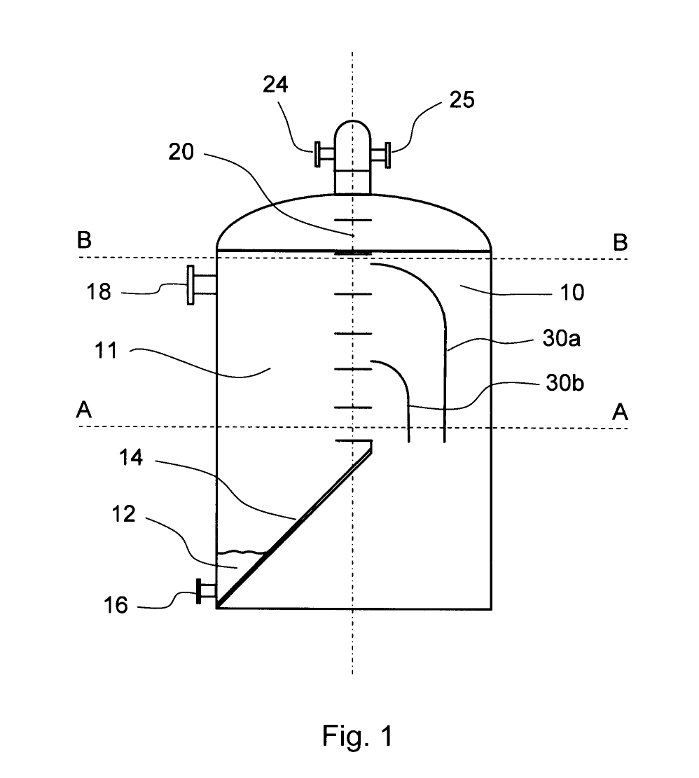

FIG. 1 shows a longitudinal section through a column having an apparatus according to the invention as overhead condenser

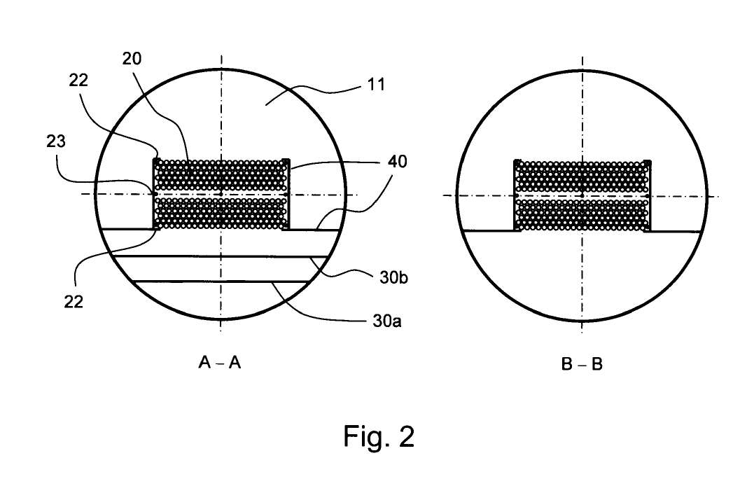

FIG. 2 shows cross sections through the top region of the column shown in FIG. 1

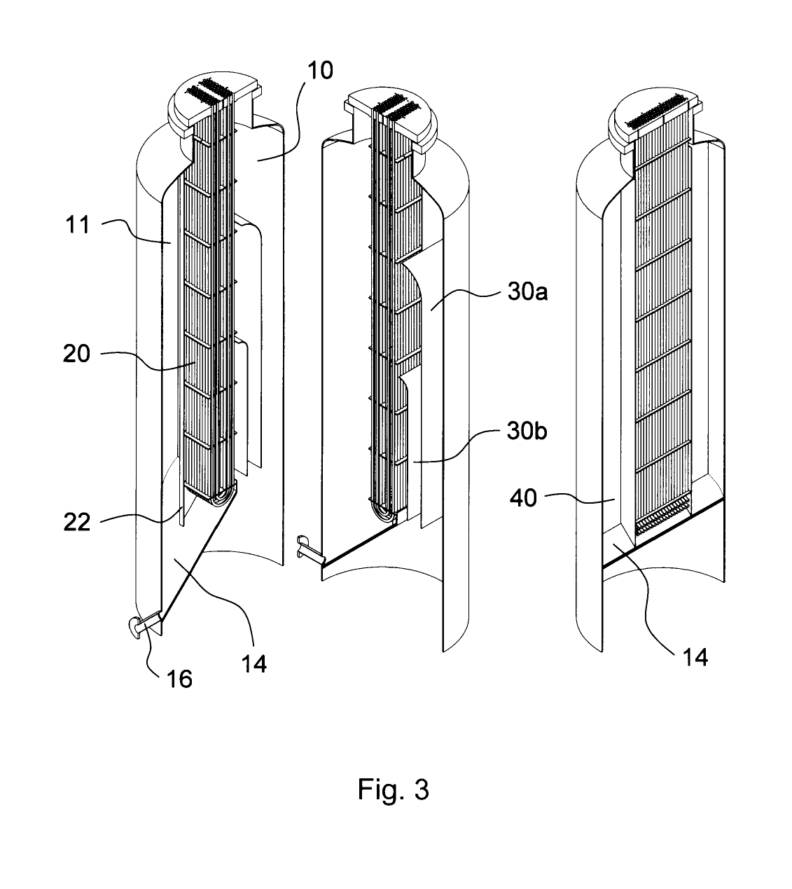

FIG. 3 shows perspective sections through a column according to the invention

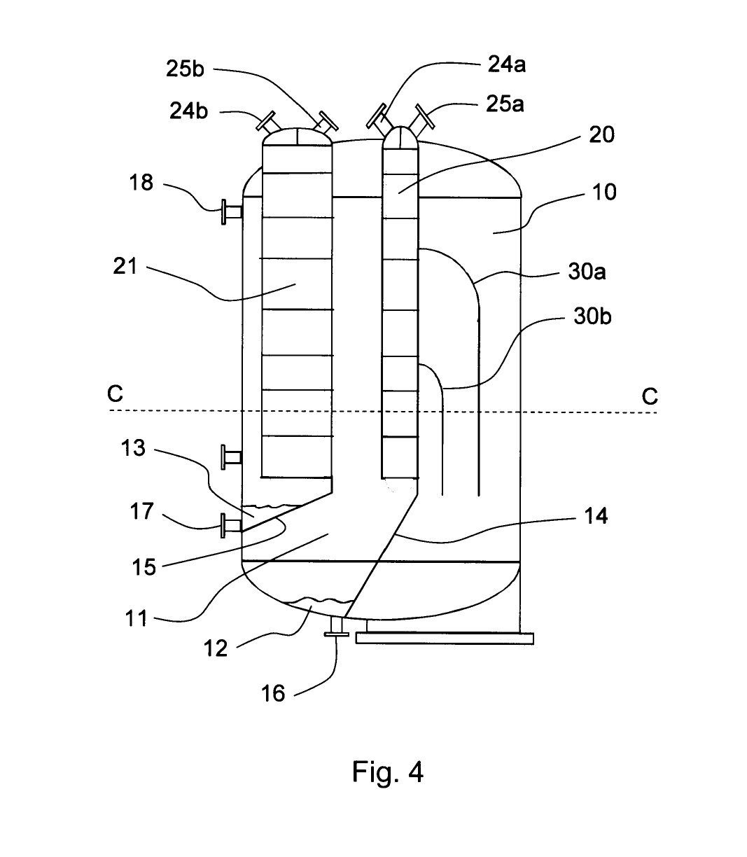

FIG. 4 shows a longitudinal section through a vessel having an apparatus according to the invention with additional heat exchanger

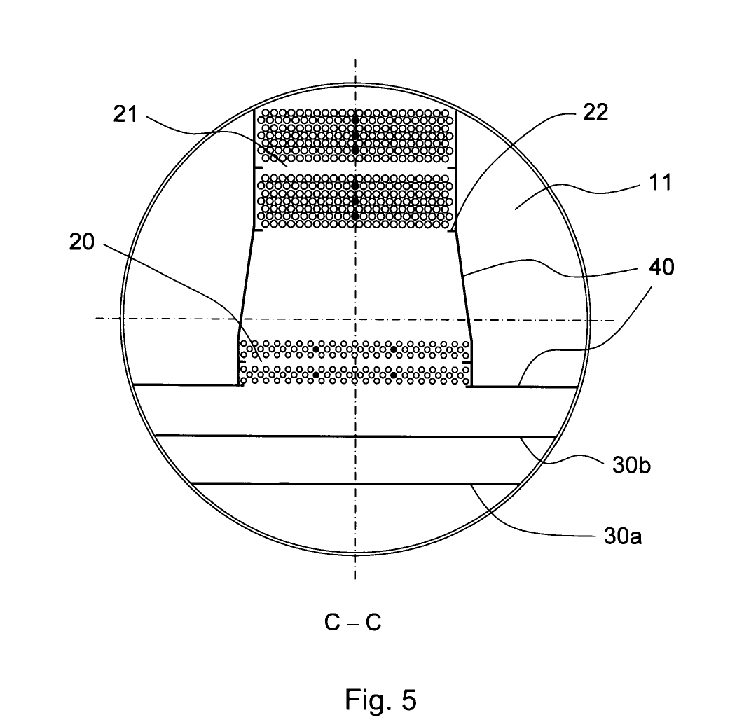

FIG. 5 shows a cross section through the vessel shown in FIG. 4

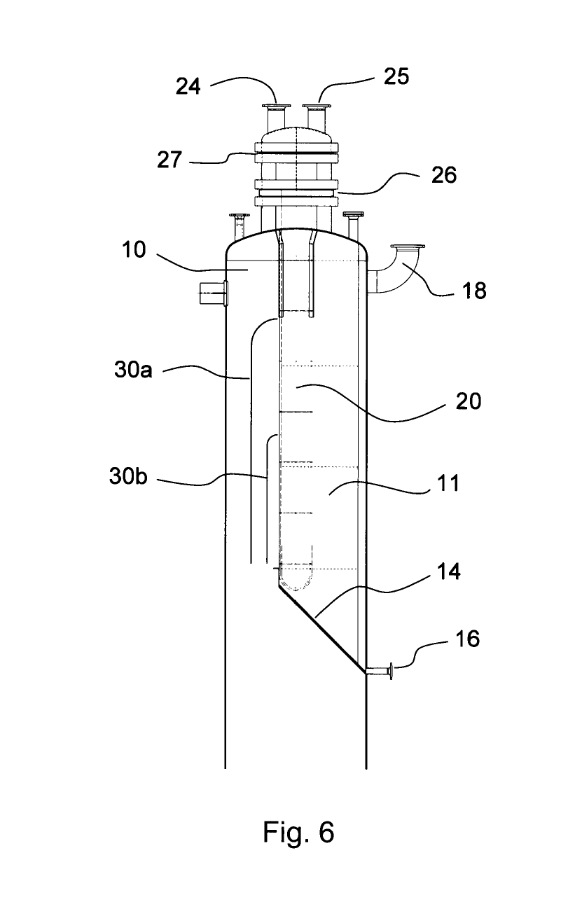

FIG. 6 shows a longitudinal section through a column having an apparatus according to the invention as overhead condenser and double flange on the column lid

List of reference numerals used
10 . . . Vapor space
11 . . . Condensation space
12 . . . First collection space
13 . . . Second collection space
14 . . . First bottom element
15 . . . Second bottom element
16 . . . First outlet
17 . . . Second outlet
18 . . . Vapor outlet
20 . . . Bundle of heat exchange elements
21 . . . Bundle of additional heat exchange elements
22 . . . Guide elements
23 . . . Holding elements
24 . . . Cooling medium inlet
25 . . . Cooling medium outlet
26 . . . First flange
27 . . . Second flange
30 . . . Deflection element
40 . . . Wall element

FIG. 1 shows a longitudinal section through the upper part of a column in which an apparatus according to the invention is installed as overhead condenser. A bundle of heat exchange elements 20 is fastened centrally on the lid of the column and extends vertically downward. Above the top of the column, an inlet 24 and an outlet 25 for a cooling medium which flows through the heat exchange elements is provided. Below the heat exchange elements, there is a bottom element 14 which extends obliquely downward from the heat exchange elements to the column wall. The bottom element 14 is joined to the column wall so as to be impermeable to fluids and together with the column wall forms a collection space 12 for condensate which forms on the heat exchanger bundle and drips into the collection space 12. An outlet 16 for the collected condensate is provided in the column wall at the lowest point of the bottom element 14.

The condensation space 11 is bounded in a downward direction by the bottom element 14 and in an upward direction by the column lid. The condensation space 11 is bounded laterally firstly by the column wall and secondly by wall elements which are arranged on the left-hand and right-hand sides between the heat exchanger bundle and the column wall (not shown in FIG. 1). The bottom element 14 and the wall elements are joined to the column wall so as to be impermeable to fluids. Two deflection elements 30a, 30b are installed in the vapor space 10 and divide the vapor ascending from the lower part of the column into three parts and divert the vertical flow into a horizontal flow, so that the vapor impinges essentially horizontally and thus orthogonally onto the heat exchange elements 20.

FIG. 2 shows two cross sections through the part of the column depicted in FIG. 1. The figure on the left-hand side corresponds to the cross section denoted by A-A in FIG. 1 just above the entry area into the vapor space. The figure on the right-hand side corresponds to the cross section denoted by B-B in FIG. 1 above the upper end of the deflection element 30a. In the example depicted, the bundle of heat exchange elements is a bundle of tubes 20 which is arranged centrally in the column and comprises six rows of U-tubes. The flow through the U-tube bundle is in this example in two streams on the tube side. The rows are in each case offset by half a tube diameter in a known 30° division, so that the vapor cannot flow through freely but is diverted around the heat exchange tubes. The heat exchanger bundle 20 does not necessarily have to be symmetrical and arranged in the middle of the column. However, for manufacturing reasons, it is advantageous for the width and arrangement of the bundle to be selected so that the bundle does not project too far into the rim region, i.e. the curved region of the column lid. The specific dimensions depend on the structural circumstances, for example the specific configuration of the column lid.

Vapor space and condensation space 11 are separated from one another by wall elements 40. The heat exchanger bundle 20 is arranged directly behind, viewed in the flow direction of the vapor, in the vertical transition plane. Furthermore, the heat exchanger bundle 20 is also bounded laterally by wall elements 40. This results in the vapor flowing from the vapor space into the condensation space 11 impinging directly on the heat exchange elements and having to flow through all rows of tubes without being able to deviate to the side. The ends of the wall elements 40 are, in this example, shaped so that they serve as guide elements for the bundle. In addition, this shape results in the vapor stream being diverted onto the heat exchange elements and not flowing in bypass between the bundle and the wall elements. At the corners and in the middle of the cross section through the bundle, there are rod-shaped holding elements 23 which are indicated in the figure as black dots. The holding elements 23 are connected to holding plates which cover the entire tube bundle cross section and fix the individual tubes in their horizontal position. The deflection elements 30a and 30b ensure uniform distribution of the vapor over the heat exchange elements, in this example in three separate volume streams.

FIG. 3 shows three perspective sections through a column according to the invention which corresponds in terms of its significant components to the in-principle sketch in FIG. 1. The arrangement of bottom element 14, wall elements 40, guide elements 22 and heat exchanger bundle 20 and deflection elements 30a and 30b can be seen clearly from this figure. The holding plates by means of which the individual tubes are fixed to the bundle can also be seen in this depiction.

FIG. 4 shows a longitudinal section through a vessel comprising an apparatus according to the invention with additional heat exchanger. FIG. 5 shows a cross section through the vessel in the plane denoted by C-C in FIG. 4. At its lower end, the vessel has a pipe section through which vapor can flow in an upward direction into the vapor space 10. A bundle of heat exchange elements 20 is installed centrally, viewed perpendicular to the drawn-in plane, in the vessel. Above the vessel lid there is an inlet 24a and an outlet 25a for a cooling medium which flows through the heat exchange elements. A first bottom element 14 is joined so as to be impermeable to fluids to the bottom and parts of the wall of the vessel and to wall elements 40. The wall elements 40 extend inward from the outer walls of the vessel in the direction of the heat exchanger bundle 20 and to the vessel lid. The vertical area which is not covered by wall elements 40 defines the vertical transition plane from the vapor space 10 into the condensation space 11.

In this example, too, two deflection elements 30a and 30b which firstly, viewed from the bottom upward, run essentially vertically and at their upper end have a cross section in the shape of a quarter circle are present in the vapor space. The vapor flowing through the pipe section into the vessel is divided into three volume streams and, owing to the deflection, impinges essentially horizontally onto the heat exchange elements. The heat exchanger is a bundle of tubes 20 which comprises three rows of U-tubes. In this example, the flow through the bundle on the tube side is in six streams. The rows are offset from one another at a known 45° division, so that the vapor cannot flow through freely but is diverted around the heat exchange tubes. Viewed in the flow direction of the vapor, a bundle of additional heat exchange elements 21 is installed in the back part of the condensation space 11 and likewise has, above the container lid, an inlet 24b and an outlet 25b for a cooling medium to flow through the additional heat exchange elements. This is a bundle of tubes having seven rows of U-tubes which are offset relative to one another at a known 30° division. The vapor flows through the bundle on the tube side in six streams in this example. At the sides, the heat exchanger bundle 20 and the additional heat exchanger bundle 21 are enclosed by wall elements 40 which are joined to one another so that a flow channel from the vertical transition plane to the back bundle is obtained. These wall elements 40 are joined so as to be impermeable to fluids to the appropriate parts of the vessel wall and the vessel lid. This ensures that the vapor is directed efficiently onto the cooling elements and cannot escape laterally into regions of the condensation space 11 in which no cooling capacity is available. Guide elements 22 for guiding and fixing the bundles are installed on the wall elements 40. Holding plates fix the individual tubes in their horizontal position and cover the entire tube bundle cross section. They are indicated in FIG. 4 by horizontal lines in the heat exchanger bundles 20 and 21.

Below the bundle of additional heat exchange elements 21 there is a second bottom element 15 which is joined to parts of the vessel wall so as to be impermeable to fluids. The first bottom element 14 and the second bottom element 15 are arranged obliquely downward from the respective heat exchanger bundle and together with the vessel wall and in the case of the first bottom element 14 also parts of the vessel bottom form a first collection space 12 and a second collection space 13 for condensate which flows from the respective heat exchange elements 20 and 21 onto the bottom elements. The collection spaces 12 and 13 are structurally separated from one another so that condensate formed on the heat exchanger bundle 20 goes exclusively into the first collection space 12 while condensate formed on the additional heat exchanger bundle 21 is collected exclusively in the second collection space 13. To discharge the respective condensate, a first outlet 16 for the first collection space 12 is provided in the vessel bottom, while a second outlet 17 for the second collection space 13 is located in the vessel wall at the lowest point of the second bottom element 15. A vapor outlet 18 through which the uncondensed proportion of the vapor can be discharged is provided in the upper region of the vessel.

Provision of the vessel with two bundles of heat exchange elements 20 and 21 which each have separate inlets and outlets for cooling media allows multistage condensation of the vapor, with the two bundles being able to be operated with different cooling powers. As a result of the condensates being collected in separate collection spaces, separation of the condensate into two fractions having differing compositions can also be achieved. Thus, for example, the bundle of the heat exchange elements 20 can be operated using a first cooling medium at a prescribed temperature level at which components of the vapor having a particular dew point condense. The uncondensed proportion of the vapor flows on to the bundle of additional heat exchangers 21 which is operated using a second cooling medium at a temperature level which is below the temperature level of the first bundle. In this case, further components of the vapor mixture which have a dew point lower than that of the components condensed predominantly on the first bundle 20 will condense on the bundle 21. If total condensation does not take place on the additional heat exchanger bundle 21, a third fraction can be taken off in vapor form through the vapor outlet 18.

FIG. 6 shows a longitudinal section through a column which has an apparatus according to the invention as overhead condenser. In this embodiment, the bundle of heat exchange elements 20 is installed detachably in the column. For this purpose, a double flange is provided as accommodation device for the heat exchanger bundle 20 at the top of the column. The bundle is joined in a gastight manner to the column by means of a first flange 26, which means that no vapor can escape from the interior of the column through this connection as long as this first flange 26 is closed. The openings of the heat exchange elements through which the cooling medium can flow is accessible from the outside when the first flange 26 is closed. A second flange 27 is provided for connecting these openings to the appropriate inlet 24 and outlet 25 for the cooling medium. Connection of the heat exchanger bundle 20 via a double flange makes it possible to inspect and optionally clean the insides and connections of the heat exchange elements without the column having to be opened. This offers advantages particularly when the column is operated at a pressure which is significantly different from the ambient pressure. This is particularly advantageous for columns which are operated under vacuum or high vacuum.

As an alternative to installation of the heat exchanger bundle or additional heat exchanger bundle on the lid of a column or a vessel, installation at the side is also possible, for example via a flange which extends vertically along the wall. Such an arrangement offers advantages in the manufacture of columns since these can frequently be equipped while horizontal. The individual heat exchange elements, for example tubes, can be arranged horizontally or vertically. In the case of installation of the bundle from the side via a flange, tube coils through which flow is essentially horizontal are preferred as heat exchange elements. In the erected state of the column, the bundle of heat exchange elements is oriented essentially vertically in this case, too, since its dimension in the vertical direction is greater than that in the horizontal direction.

A further advantage of this arrangement is that the wall region of the column or of the vessel can also be provided with heat exchange elements, while in the case of introduction via the lid the curvature of the lid in the rim region imposes narrower limits. In the case of installation of the heat exchanger bundle or additional heat exchanger bundle from the side, the inlets and outlets for cooling media are advantageously also provided at the side. In the case of installation via a lateral flange, the heat exchanger bundles can also be fastened detachably in the vessel or the column.

1. An apparatus for condensing vapor in a vessel, which comprises a vapor space (10) and a condensation space (11) which are adjacent to one another in the horizontal direction, where the vapor space (10) having a horizontal open cross section is open in the downward direction, the condensation space (11) is closed in the downward direction by at least one bottom element (14) and at least one essentially vertically aligned bundle of heat exchange elements (20) is arranged in the condensation space, wherein wall elements (40) are present between vapor space and condensation space and partly separate the two spaces from one another and define a vertical transition plane from the vapor space into the condensation space and at least one deflection element (30) is present in the vapor space to divert the vapor ascending from below into the vapor space in the direction of the transition plane and owing to its shape brings about an essentially horizontal flow of vapor through the transition plane onto the heat exchange elements.

2. The apparatus according to claim 1, wherein at least two deflection elements (30) which divide the horizontal open cross section into at least three entry areas on entry into the vapor space (10) and divide the vertical transition plane from the vapor space (10) into the condensation space (11) into at least three exit areas are present, where the number of entry areas is equal to the number of exit areas.

3. The apparatus according to claim 2, wherein the geometric areas of the entry areas are selected so that the volume flows through the respective entry areas differ from one another by not more than 10%, preferably not more than 5%, and the geometric areas of the exit areas differ from one another by not more than 10%, preferably not more than 5%.

4. The apparatus according to claim 2, wherein the geometric areas of the entry areas differ from one another by not more than 10%, preferably not more than 5%, and the geometric areas of the exit areas differ from one another by not more than 10%, preferably not more than 5%.

5. The apparatus according to any of claims 1 to 4, wherein the deflection elements (30) have a rounding such that the vapor flow at the transition from the vertical flow direction on entry into the vapor space (10) to the horizontal flow direction on entry into the condensation space (11) is essentially free of turbulence or eddies.

6. The apparatus according to any of claims 1 to 5, wherein a first bottom element (14) is arranged at least partly below the at least one bundle of heat exchange elements (20) so that condensate formed on this bundle can be collected by the first bottom element (14) and owing to its shape either alone or together with part of the vessel wall and/or the wall elements (40) forms a first collection space (12) for the condensate.

7. The apparatus according to any of claims 1 to 6, wherein a bundle of additional heat exchange elements (21) is present downstream, in the flow direction of the vapor, of the at least one bundle of heat exchange elements (20) in the condensation space (11).

8. The apparatus according to claim 7, wherein a second bottom element (15) is arranged in the condensation space (11) at least partly below the bundle of additional heat exchange elements (21) so that condensate formed on this bundle can be collected by the second bottom element (15) and, owing to its shape, either alone or together with part of the vessel wall and/or the wall elements (40) forms a second collection space (13) for this condensate.

9. The apparatus according to claim 8, wherein the second collection space (13) is separate from the first collection space (12) and at least two outlets (17, 18) for separate discharge of the condensates from the two collection spaces (12, 13) are present.

10. The apparatus according to any of claims 1 to 9, the at least one bundle of heat exchange elements (20) and/or the bundle of additional heat exchange elements (21) are bundles of tubes.

11. A column in which an apparatus according to any of claims 1 to 10 is arranged as overhead condenser in the top region of the column and which further comprises one or more cooling medium inlets (24) and one or more cooling medium outlets (25) for the heat exchange elements and optionally additional heat exchange elements and also at least one outlet (17, 18) for discharging the condensate collecting in the condensation space.

12. The column according to claim 11, wherein the at least one bundle of heat exchange elements (20) and/or the bundle of additional heat exchangers (21) is installed in a removable manner in the column.

13. The column according to claim 11 or 12, wherein the lid of the column has an accommodation device for the at least one bundle of heat exchange elements (20, 21), where the accommodation device comprises a double flange in which the bundle or bundles of heat exchange elements is/are joined in a gastight manner by a first flange (26) to the column and the cooling medium side of the heat exchange elements is accessible via the second flange (27).

14. A method of condensing a vapor stream by means of an apparatus according to at least one of claims 1 to 10, wherein the absolute pressure in the vapor space (10) does not exceed 200 mbar, preferably 50 mbar, in particular 10 mbar.

15. A method of condensing a vapor stream by means of an apparatus according to at least one of claims 1 to 10, wherein the vapor stream comprises components which form deposits on the heat exchange elements during condensation.
